(19) United States
(12) Patent Application Publication
(10) Pub. No.: US 2025/0244647 A1
(43) Pub. Date: Jul. 31, 2025

(54) PROJECTOR WITH STAND

(71) Applicant: SEIKO EPSON CORPORATION, Tokyo (JP)

(72) Inventor: Yusaku TAKAMINE, AZUMINO-SHI (JP)

(21) Appl. No.: 19/036,467

(22) Filed: Jan. 24, 2025

(30) Foreign Application Priority Data
Jan. 25, 2024 (JP) 2024-009314

(51) Int. Cl. G03B 21/14

(52) U.S. Cl. CPC G03B 21/145

(57) ABSTRACT

A projector with stand includes a projector including a projection port, a speaker disposed in the projector, and a stand supporting the projector. An acoustic diffusion unit that reflects and diffuses sound emitted from the speaker is provided on a surface of the stand facing the projector.

The present application is based on, and claims priority from JP Application Serial Number 2024-009314, filed Jan. 25, 2024, the disclosure of which is hereby incorporated by reference herein in its entirety.

### BACKGROUND

### 1. Technical Field

The present disclosure relates to a projector with stand.

### 2. Related Art

In order to make it possible to freely set a position at which an image is projected, a projector with stand including a rotary stand that displaces an inclination angle of a projector is used. For example, a projector device of JP-A-2005-10391 includes a support device serving as a stand that rotatably supports a projector main body. The support device includes an attachment case for attaching the projector main body and a support base that rotatably supports the attachment case centering on a horizontal rotation center axis.

A projector with a speaker in which a speaker is incorporated in a projector to make it possible to play a video with voice has been used. When a speaker is incorporated in a small projector that is easily carried, the speaker is sometimes disposed at the rear end portion of the projector on the side opposite to a projection lens because of a restriction of a layout inside the projector. In this case, a sound emitting port is provided on the rear surface of the projector to emit sound rearward.

JP-A-2005-10391 is an example of the related art.

When viewing a movie or the like using a projector with stand, an image is sometimes projected onto a ceiling with the projector directed upward. When a sound emitting port is provided on the rear surface of the projector, the sound emitting port faces downward when the projector is directed upward and the sound emitting port is in a posture facing the stand. Therefore, sound is blocked by the stand.

In sound emitted from a speaker, sound in a low frequency range relatively tends to spread in all direction. Therefore, the sound in the low frequency range easily spread to the surrounding even if the stand is present in the front of the sound emitting port. On the other hand, since sound in a high frequency range has strong directivity, the sound in the high frequency range less easily spreads to the surrounding in a state in which the stand is present in the front of the sound emitting port. Therefore, in the posture of the sound emitting port facing the stand, the sound in the high frequency range does not spread to the surrounding and a sense of presence is reduced.

In order to solve the problems described above, a projector with stand of the present disclosure includes: a projector including a projection port; a speaker disposed in the projector; and a stand configured to support the projector. An acoustic diffusion unit configured to reflect and diffuse sound emitted from the speaker is provided on a surface of the stand facing the projector.

In order to solve the problems described above, a projector with stand of the present disclosure includes: a projector including a projection port; a stand configured to support the projector; and a speaker disposed in the stand. An acoustic diffusion unit configured to reflect and diffuse sound emitted from the speaker is provided on a surface of the projector facing the stand.

In order to solve the problems described above, a projector with stand of the present disclosure includes: a projector including a projection port; a speaker disposed in the projector; and a stand configured to support the projector. The stand includes: a sound receiving port opened on a surface facing the projector; a sound emitting port opened on a surface different from the surface facing the projector; and an acoustic transmission path configured to cause the sound receiving port with the sound emitting port to communicate.

### BRIEF DESCRIPTION OF THE DRAWINGS

FIG. 1 is a side view of a projector with stand in a first embodiment.

FIG. 2 is a front view of the projector with stand in the first embodiment.

FIG. 3 is a diagram illustrating an acoustic diffusion unit.

FIG. 4 is a diagram illustrating an acoustic diffusion unit in a modification 1.

FIG. 5 is a diagram illustrating an acoustic diffusion unit in a modification 2.

FIG. 6 is a diagram illustrating an acoustic diffusion unit in a modification 3.

FIG. 7 is a side view of a projector with stand in a second embodiment.

FIG. 8 is a side view of a projector with stand in a third embodiment.

FIG. 9 is a diagram illustrating an acoustic diffusion unit in a modification 4.

FIG. 10 is a side view of a projector with stand in a fourth embodiment.

### DESCRIPTION OF EMBODIMENTS

Projectors with a stand according to embodiments of the present disclosure are explained below with reference to the drawings.

### First Embodiment

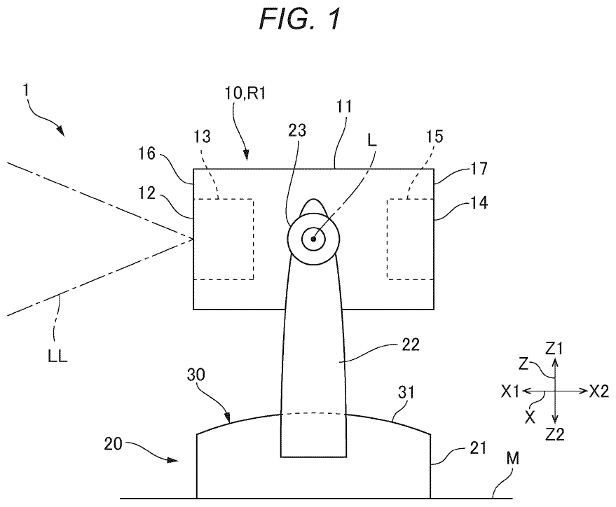

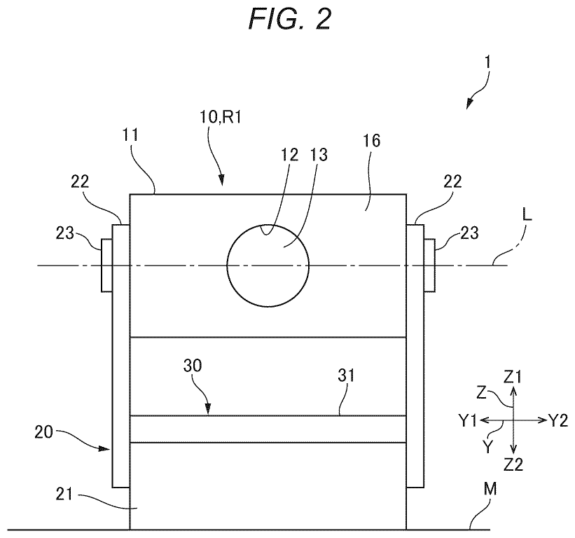

FIG. 1 is a side view of a projector with stand 1 in a first embodiment. FIG. 2 is a front view of the projector with stand 1 in the first embodiment. In the present specification, an X direction, a Y direction, and a Z direction are directions orthogonal to one another. One side in the Z direction is represented as a Z1 direction and the other side in the Z direction is represented as a Z2 direction. One side in the X direction is represented as an X1 direction and the other side in the X direction is represented as an X2 direction. One side in the Y direction is represented as a Y1 direction and the other side in the Y direction is represented as a Y2 direction.

FIGS. 1 and 2 illustrate a state in which the projector with stand 1 is installed on an upward installation surface M and projection light LL is projected toward a wall surface. In FIGS. 1 and 2, the Z direction is an up-down direction. The Z1 direction is an upward direction and the 22 direction is a downward direction. The X direction is a front-rear direction of the projector with stand 1. The X1 direction is a forward direction and the X2 direction is a rearward direction. The X1 direction is an image projection direction. As explained below, the projector with stand 1 is capable of adjusting a projection direction of projection light LL in a range including the X1 direction and the Z2 direction. The Y direction is a width direction of the projector with stand 1. The projector with stand 1 can be installed on a surface facing any direction and used.

As illustrated in FIGS. 1 and 2, the projector with stand 1 includes a projector 10 and a stand 20. The stand 20 is a support device that rotatably supports the projector 10. The stand 20 includes a base 21 disposed on the installation surface M and a pair of support columns 22 extending in the Z1 direction from the base 21. The projector 10 is disposed between the pair of support columns 22 and is rotatably coupled to a rotation support unit 23 provided at the distal ends of the support columns 22. Accordingly, the projector 10 is rotatably supported centering on a rotation axis L extending in the Y direction. The rotation support unit 23 includes, for example, a shaft portion provided in the projector 10 and one support column 22 and a bearing section provided in the projector 10 and the other support column 22 and rotatably supporting the shaft portion.

As illustrated in FIG. 1, the projector 10 includes an exterior case 11 and a projection optical system 13 disposed on the inner side of a projection port 12 provided in the exterior case 11. The projector 10 emits the projection light LL to the outside from the projection port 12. The projector 10 includes a light source, an image generation unit, and a control unit, which are not illustrated, housed in the exterior case 11 and a speaker 15 disposed on the inner side of a sound emitting port 14 provided in the exterior case 11. The projector 10 may have a configuration in which a part of a lens frame and a lens barrel of the projection optical system 13 protrudes to the outside from the projection port 12.

The control unit causes the image generation unit to operate based on an image signal such as a video signal from the outside and supplies an acoustic signal associated with the image signal to the speaker 15 to cause the speaker 15 to operate. The image generation unit is, for example, a liquid crystal panel. The projector 10 enlarges and projects, with the projection optical system 13, an image generated by the image generation unit.

In an example illustrated in FIGS. 1 and 2, the exterior case 11 has a rectangular parallelepiped shape. The exterior case 11 includes a front surface 16 on which the projection port 12 is provided and a rear surface 17 facing the side opposite to the front surface 16. The sound emitting port 14 is provided on the rear surface 17. The sound emitting port 14 may be a single opening or may be a perforated plate in which a plurality of holes are provided. The projector 10 emits sound generated by the speaker 15 to the outside from the sound emitting port 14. In the example illustrated in FIGS. 1 and 2, the sound emitting port 14 and the speaker 15 are disposed at the end portion on an emission side of the projector 10, in other words, at the end portion on the side opposite to the end portion where the projection port 12 is provided. Therefore, the sound emitted from the speaker 15 is emitted to the side opposite to the projection light LL.

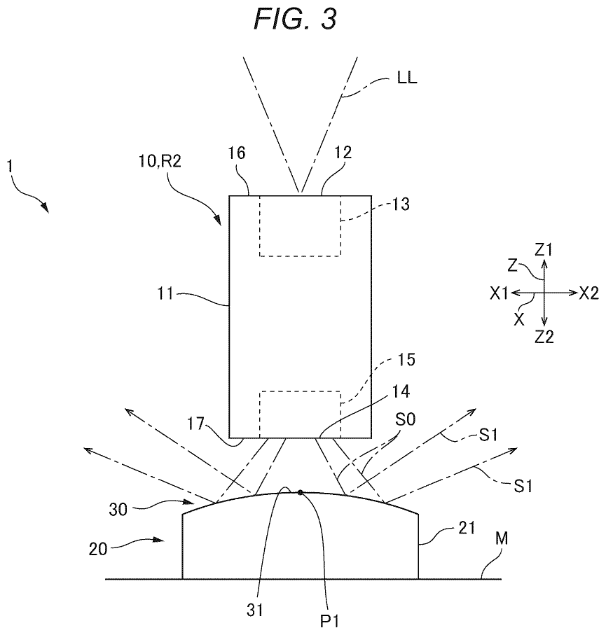

A rotation range of the projector 10 is a range including at least a first rotation position R1 (see FIGS. 1 and 2) where the projection port 12 faces the X1 direction and a second rotation position R2 (see FIG. 3) where the projection port 12 faces the Z1 direction. At the first rotation position R1, a video can be projected from the projector 10 onto a wall surface. In the second rotation position R2, a video can be projected from the projector 10 onto a ceiling surface. At the second rotation position R2, the speaker 15 faces the Z2 direction. Therefore, at the second rotation position R2, the speaker 15 faces the stand 20.

For example, with the first rotation position R1 set as a reference position, the projector 10 is supported to be capable of rotating 90° from the reference position (the first rotation position R1) toward the Z2 direction side and to be capable of rotating 120° from the reference position (the first rotation position R1) toward the Z1 direction side. The rotation range of the projector 10 is not limited to this range. For example, the projector 10 may be capable of rotating 360°. The stand 20 includes a holding mechanism that holds the projector 10 at any rotation position or at a plurality of preset rotation positions.

### Acoustic Diffusion Unit

An acoustic diffusion unit 30 that reflects and diffuses the sound emitted from the speaker 15 is provided on a surface of the stand 20 facing the projector 10. As illustrated in FIGS. 1 and 2, the projector 10 is held at a position facing the base 21 of the stand 20. Therefore, the upper surface of the base 21 is a surface facing the projector 10 and the acoustic diffusion unit 30 is provided on the upper surface of the base 21. In the example illustrated in FIGS. 1 and 2, the entire upper surface of the base 21 configures the acoustic diffusion unit 30. The acoustic diffusion unit 30 may be provided limited in a part of the upper surface of the base 21. For example, the acoustic diffusion unit 30 may be provided limitedly in a range facing the projector 10 rotated to the second rotation position R2.

FIG. 3 is a diagram illustrating the acoustic diffusion unit 30. In FIG. 3, illustration of the pair of support columns 22 and the rotation support unit 23 provided in the stand 20 is omitted. In a state in which the projector 10 is rotated to the second rotation position R2, the sound emitting port 14 and the upper surface of the base 21 face each other as illustrated in FIG. 3. Therefore, the speaker 15 faces the acoustic diffusion unit 30 via the sound emitting port 14. The sound emitted from the speaker 15 travels from the sound emitting port 14 toward the acoustic diffusion unit 30 and is reflected and diffused by the acoustic diffusion unit 30.

The acoustic diffusion unit 30 has a convex shape protruding to the projector 10 side. As illustrated in FIG. 3, the acoustic diffusion unit 30 includes a single convex section 31 having one vertex P1. In a state in which the projector 10 is rotated to the second rotation position R2, the vertex P1 of the convex section 31 and the center of the sound emitting port 14 face each other.

In FIG. 3, spread of the sound emitted from the speaker 15 is indicated by an alternate long and short dash line S0 and spread of reflected sound reflected by the acoustic diffusion unit 30 is indicated by an alternate long and short dash line S1. The surface of the acoustic diffusion unit 30 is a convex curved surface. The convex curved surface excluding a vertex P is formed by a surface facing the outer peripheral side. Therefore, the reflected sound reflected by the acoustic diffusion unit 30 spreads to the outer peripheral side. In the convex curved surface, the tilt of a tangent line decreases toward the vertex P and the tilt of the tangent line increases toward the outer peripheral side. For that reason, sound reflected in an outer peripheral region of the acoustic diffusion unit 30 has a larger tilt with respect to the Z direction than sound reflected in an inner peripheral region. Therefore, the reflected sound reflected by the acoustic diffusion unit 30 greatly spreads to the outer peripheral side and is diffused in a wide range.

### Action Effects of the Embodiment

The projector with stand 1 in the first embodiment includes the projector 10 including the projection port 12, the speaker 15 disposed in the projector 10, and the stand 20 supporting the projector 10. The acoustic diffusion unit 30 that reflects and diffuses the sound emitted from the speaker 15 is provided on the surface of the stand 20 facing the projector 10.

Accordingly, even when sound is emitted from the speaker 15 toward the stand 20, the sound is reflected and diffused by the acoustic diffusion unit 30. Therefore, it is possible to suppress deterioration in a sound effect due to the sound emitted from the speaker 15 being blocked by the stand 20. In particular, even sound in a high frequency range can be expanded the surrounding by the acoustic diffusion unit 30. Thus, it is possible to suppress deterioration in a sense of presence obtained from a video with voice.

The acoustic diffusion unit 30 has a convex shape protruding to the projector 10 side. Therefore, since sound is reflected by a surface facing the outer peripheral side, the reflected sound travels toward the outer peripheral side. Thus, it is possible to spread the sound to the surrounding. The surface of the acoustic diffusion unit 30 is the convex curved surface. Therefore, the reflected sound can be spread in a wide range.

The stand 20 in the first embodiment rotatably supports the projector 10. The rotation range of the projector 10 includes the second rotation position R2 where the speaker 15 and the acoustic diffusion unit 30 face each other. Accordingly, the projection direction of the projection light LL can be adjusted. When the speaker 15 is used in a state in which the sound is emitted from the speaker 15 toward the stand 20 because of the change in the projection direction, the sound is reflected and diffused by the acoustic diffusion unit 30. Accordingly, even sound in a high frequency range can be spread to the surrounding by the acoustic diffusion unit 30. It is possible to suppress deterioration in a sense of presence obtained from the video with voice.

### Modification of the Acoustic Diffusion Unit

The acoustic diffusion unit 30 only has to have a shape in which a portion reflecting the sound of the speaker 15 faces the outer peripheral side, in other words, a convex shape protruding to the projector 10 side. The shape of the acoustic diffusion unit 30 is not limited to the shape illustrated in FIG. 3. For example, shapes of modifications 1 to 3 explained below can be adopted.

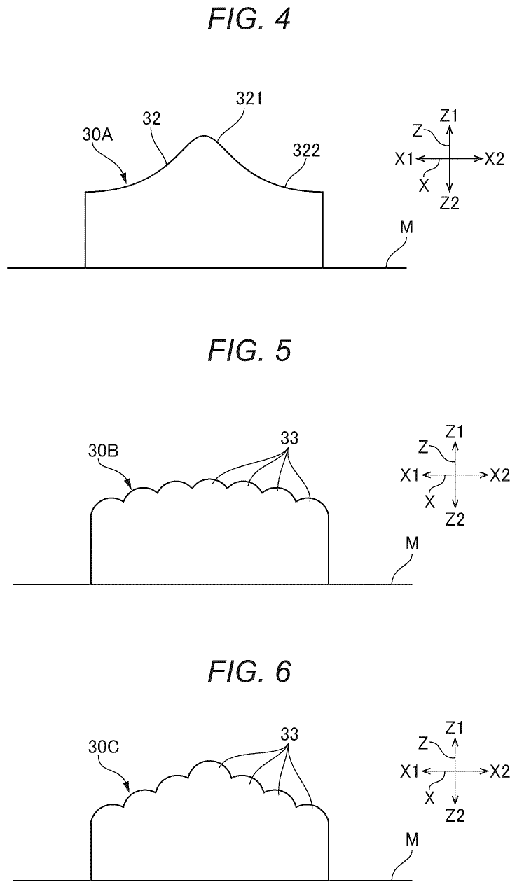

FIG. 4 is a diagram illustrating an acoustic diffusion unit 30A in the modification 1. As in the first embodiment, the acoustic diffusion unit 30A includes the single convex section 32 protruding to the projector 10 side. The surface of the acoustic diffusion unit 30A includes a center region 321 centering on the vertex of the convex section 32 and an outer peripheral region 322 surrounding the center region 321. In the surface of the acoustic diffusion unit 30A, the center region 321 is a convex curved surface and the outer peripheral region 322 is a concave curved surface. The center region 321 has a shape in which the tilt of a tangent line increases toward the outer peripheral side. The outer peripheral region 322 has a shape in which the tilt of a tangent line decreases toward the outer peripheral side and approaches 0.

The surface of the acoustic diffusion unit 30A is the same as the surface in the first embodiment in that, although the outer peripheral region 322 is the concave curved surface, the surface excluding the vertex of the center region 321 is a surface facing the outer peripheral side. Accordingly, the reflected sound can be diffused to the surrounding and even sound in a high frequency range can be spread.

FIG. 5 is a diagram illustrating an acoustic diffusion unit 30B in the modification 2. FIG. 6 is a diagram illustrating an acoustic diffusion unit 30C in the modification 3. A plurality of convex sections 33 are disposed on the surfaces of the acoustic diffusion units 30B and 30C. The surfaces of the convex sections 33 are convex curved surfaces. Both of the acoustic diffusion units 30B and 30C have a shape in which the plurality of convex sections 33 are arranged side by side on the surface of a single convex shape highest in the center. In the acoustic diffusion unit 30B illustrated in FIG. 5, the plurality of convex sections 33 are arranged side by side on the curved surface. On the other hand, the acoustic diffusion unit 30C illustrated in FIG. 6 is higher in the center than the acoustic diffusion unit 30B. In the acoustic diffusion unit 30C, the plurality of convex sections 33 are arranged side by side on a conical surface.

Since the plurality of convex sections 33 are arranged side by side on the surfaces of the acoustic diffusion units 30B and 30C, a sound diffusion effect is improved. That is, not only sound reflected at a position on the outer peripheral side but also sound reflected at a position on the inner peripheral side can be spread to the surrounding. The shape of the convex sections 33 of the acoustic diffusion units 30B and 30C is set such that reflected sound reflected on the surfaces of the convex sections 33 travels in a direction in which the reflected sound does not collide with the surfaces of the convex sections 33 adjacent to each other. Therefore, since the sound is repeatedly reflected between the convex sections 33 adjacent to each other, it is possible to avoid a decrease in sound traveling to the outer peripheral side.

In the examples illustrated in FIGS. 5 and 6, all of the plurality of convex sections 33 arranged side by side on the surfaces of the acoustic diffusion units 30B and 30C have the same shape. However, the plurality of convex sections 33 may have different sizes and shapes.

The convex section 31 in the first embodiment and the convex sections 32 and 33 of the modifications 1 to 3 may have a convex shape with a sharp tip. For example, the shape may be a conical shape or a pyramid shape. Alternatively, the shape may be a shape obtained by cutting the tip of the conical shape or the pyramid shape with a plane.

### Other Modifications

The external shape of the projector 10 is not limited to a rectangular parallelepiped shape illustrated in FIGS. 1 and 2. For example, the external shape may be a cylindrical shape or may be another shape such as a spherical shape.

A surface on which the sound emitting port 14 is provided may not be the rear surface 17 of the projector 10. The surface on which the sound emitting port 14 is provided may be a surface facing the stand 20 at any rotation position within the rotation range of the projector 10. For example, the sound emitting port 14 may be provided on a side surface of the projector 10 facing in the Z1 direction or the Z2 direction in FIG. 1.

A configuration in which the projector 10 is fixed to the stand 20 and is not rotatable may be adopted. In this case, the sound emitting port 14 is provided on a surface facing the stand 20 in the projector 10 in a fixed state and the speaker 15 is disposed on the inner side of the sound emitting port 14.

### Second Embodiment

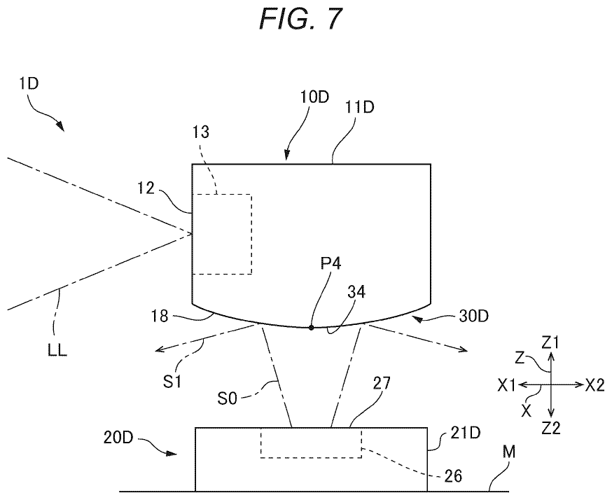

FIG. 7 is a side view of a projector with stand 1D in a second embodiment. The projector with stand 1D includes a projector 10D and a stand 20D. The projector with stand 1D is configured the same as in the first embodiment except that disposition of an acoustic diffusion unit and a speaker is different from the disposition in the first embodiment and that the projector 10D is not rotatable.

The projector 10D includes an exterior case 11D, the projection optical system 13 disposed on the inner side of the projection port 12 provided in the exterior case 11D, and a light source, an image generation unit, and a control unit, which are not illustrated, housed in the exterior case 11D. The projector 10D emits the projection light LL to the outside from the projection port 12.

The stand 20D includes a base 21D placed on the installation surface M and a pair of support columns extending in the Z1 direction from the base 21D. The projector 10D is disposed between the pair of support columns and is held at a position facing the upper surface of the base 21D by the pair of support columns. The projector 10D is fixed to the stand 20D in a posture in which the projection port 12 faces the X1 direction. In FIG. 7, illustration of the pair of support columns is omitted.

The projector with stand 1D includes a speaker 26 disposed in the stand 20D. In the stand 20D, a sound emitting port 27 is provided on a surface facing the projector 10D and the speaker 26 is disposed on the inner side of the sound emitting port 27. The projector with stand 1D emits sound generated by the speaker 26 from the sound emitting port 27 toward the projector 10D. In an example illustrated in FIG. 7, the sound emitting port 27 is provided on the upper surface of the base 21D and sound is radiated in the Z1 direction.

An acoustic diffusion unit 30D that reflects and diffuses the sound emitted from the speaker 26 is provided on a surface of the projector 10D facing the stand 20D. In the example illustrated in FIG. 7, a side surface 18 facing the Z2 direction among side surfaces of the exterior case 11D faces the stand 20D in the projector 10D. The entire side surface 18 facing the Z2 direction in the projector 10D configures the acoustic diffusion unit 30D. The speaker 26 faces the acoustic diffusion unit 30D via the sound emitting port 27.

In the example illustrated in FIG. 7, the projector 10D is fixed to the stand 20D in a posture in which the projection port 12 faces the X1 direction. However, the direction of the projection port 12 is not limited to this direction. For example, the projector 10D may be fixed in a posture in which the projection port 12 faces the Z1 direction. In this case, the surface facing the stand 20D is the rear surface 17 and the acoustic diffusion unit 30D is provided on the rear surface 17.

The acoustic diffusion unit 30D is configured the same as the acoustic diffusion unit 30 in the first embodiment. That is, the acoustic diffusion unit 30D has a convex shape protruding to the base 21D side. The acoustic diffusion unit 30D includes a single convex section 34 protruding to the base 21D side. As illustrated in FIG. 7, a vertex P4 of the convex section 34 and the center of the sound emitting port 27 face each other. The surface of the acoustic diffusion unit 30 is a convex curved surface.

### Action Effects of the Second Embodiment

The projector with stand 1D according to the second embodiment includes the projector 10D including the projection port 12, the stand 20D supporting the projector 10D, and the speaker 26 disposed in the stand 20D. The acoustic diffusion unit 30D that reflects and diffuses the sound emitted from the speaker 26 is provided on the surface of the projector 10D facing the stand 20D.

Accordingly, the sound emitted from the speaker 26 toward the projector 10D is reflected and diffused by the acoustic diffusion unit 30D. Therefore, it is possible to suppress deterioration in a sound effect due to the sound emitted from the speaker 26 being blocked by the projector 10D. In particular, even sound in a high frequency range can be spread to the surrounding by the acoustic diffusion unit 30D. Thus, it is possible to suppress deterioration in a sense of presence obtained from a video with voice.

The acoustic diffusion unit 30D has a convex shape protruding to the speaker 26 side. Therefore, since sound can be reflected by the surface facing the outer peripheral side, reflected sound travels to the outer peripheral side. Thus, it is possible to spread the sound to the surrounding. The surface of the acoustic diffusion unit 30D is a convex curved surface. Therefore, the reflected sound can be diffused in a wide range.

Note that all of the configurations in the modifications 1 to 3 of the first embodiment can be applied to the acoustic diffusion unit 30D in the second embodiment.

### Third Embodiment

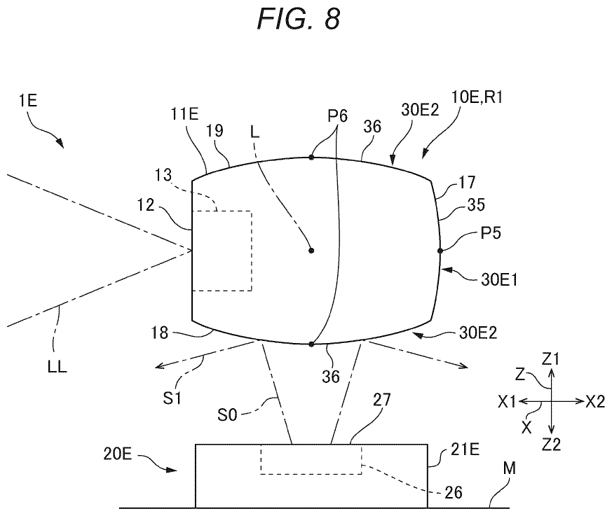

FIG. 8 is a side view of a projector with stand 1E in a third embodiment. The projector with stand 1E includes a projector 10E and a stand 20E. The projector 10E is rotatably supported by the stand 20E.

The stand 20E includes a base 21E placed on the installation surface M and a pair of support columns extending in the Z1 direction from the base 21E. The projector 10E is disposed between the pair of support columns and is rotatably coupled to a rotation support unit provided at the tips of the support columns. Accordingly, the projector 10E is rotatably supported centering on the rotation axis L extending in the Y direction. In FIG. 8, illustration of the pair of support columns and the rotation support unit is omitted.

A rotation range of the projector 10E is a range including at least the first rotation position R1 (see FIG. 8) in which the projection port 12 faces the X1 direction, a second rotation position in which the projection port 12 faces the Z1 direction, and a third rotation position in which the projection port 12 faces the X2 direction. The stand 20E includes a holding mechanism that holds the projector 10E at any rotation position or at a preset plurality of rotation positions.

In the stand 20E, as in the stand 20D in the second embodiment, the sound emitting port 27 is provided on the upper surface of the base 21E. The projector with stand 1E emits sound generated by the speaker 26 disposed on the inner side of the sound emitting port 27 from the sound emitting port 27 toward the projector 10E.

An exterior case 11E of the projector 10E includes the rear surface 17 facing the side opposite to the projection port 12. The exterior case 11E includes a pair of side surfaces 18 and 19 that intersects the front-rear direction from the projection port 12 toward the rear surface 17 and faces both sides in a direction intersecting the rotation axis L of the projector 10E. As illustrated in FIG. 8, at the first rotation position R1, the front-rear direction from the projection port 12 toward the rear surface 17 coincides with the X direction and, of the pair of side surfaces 18 and 19, the side surface 18 faces the Z2 direction and the side surface 19 faces the Z1 direction.

The projector 10E includes an acoustic diffusion unit 30E1 provided on the rear surface 17 and acoustic diffusion units 30E2 provided on each of the pair of side surfaces 18 and 19. In an example illustrated in FIG. 8, the entire rear surface 17 configures the acoustic diffusion unit 30E1. The acoustic diffusion unit 30E1 includes a single convex section 35 that protrudes toward the outer side of the exterior case 11E. Similarly, each of the entire side surface 18 and the entire side surface 19 configures the acoustic diffusion unit 30E2. The acoustic diffusion unit 30E2 includes a single convex section 36 that protrudes toward the outer side of the exterior case 11E.

The surfaces of the acoustic diffusion unit 30E1 and the acoustic diffusion units 30E2 are convex curved surfaces. At the second rotation position where the rear surface 17 faces the stand 20E, the acoustic diffusion unit 30E1 protrudes to the stand 20E side and a vertex P5 of the acoustic diffusion unit 30E1 and the center of the sound emitting port 27 face each other. At the first rotation position R1 where the side surface 18 faces the stand 20E and the third rotation position where the side surface 19 faces the stand 20E, the acoustic diffusion unit 30E2 protrudes to the stand 20E side and a vertex P6 of the acoustic diffusion unit 30E2 and the center of the sound emitting port 27 face each other.

### Action Effects of the Third Embodiment

In the projector with stand 1E in the third embodiment, the stand 20E rotatably supports the projector 10E. The rotation range of the projector 10E includes a rotation position where the speaker 26 and the acoustic diffusion units 30E1 and 30E2 face each other.

Accordingly, the projection direction of the projection light LL can be adjusted. The sound emitted from the speaker 26 toward the projector 10E is reflected and diffused by the acoustic diffusion units 30E1 and 30E2. Therefore, it is possible to suppress deterioration in a sound effect due to the sound emitted from the speaker 26 being blocked by the projector 10E. In particular, even sound in a high frequency range can be spread to the surrounding.

The projector with stand 1E includes the rear surface 17 facing the side opposite to the projection port 12 and includes the pair of side surfaces 18 and 19 that intersects with the front-rear direction from the projection port 12 toward the rear surface 17 and faces both the sides in the direction intersecting the rotation axis L of the projector 10E. The acoustic diffusion unit 30E1 is provided on the rear surface 17 and the acoustic diffusion unit 30E2 is provided on the pair of side surfaces 18 and 19, respectively. The stand 20E rotatably supports the projector 10E in a range including the first rotation position R1 where the speaker 26 faces the side surface 18, the second rotation position where the speaker 26 faces the rear surface 17, and the third rotation position where the speaker 26 faces the side surface 19.

Accordingly, the projection direction of the projection light LL can be adjusted over a wide range of 180° or more. At the first rotation position R1, the second rotation position, and the third rotation position, the sound emitted from the speaker 26 toward the projector 10E is reflected and diffused by the acoustic diffusion units 30E1 and 30E2. Therefore, even sound in a high frequency range can be spread to the surrounding.

### Modifications

All of the configurations of the modifications 1 to 3 of the first embodiment can be applied to the acoustic diffusion units 30E1 and 30E2 in the third embodiment.

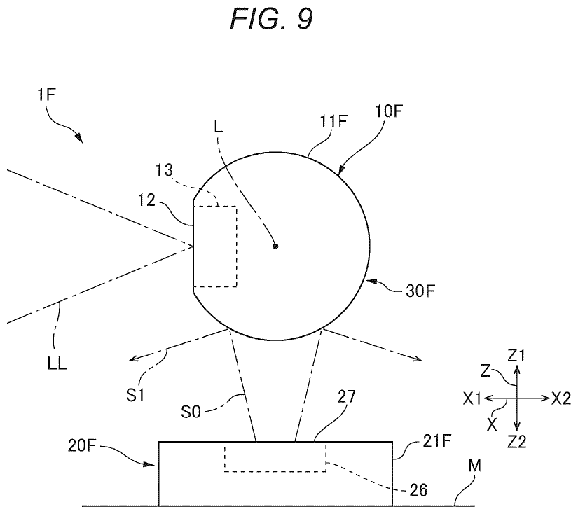

FIG. 9 is a diagram illustrating an acoustic diffusion unit 30F in a modification 4. As illustrated in FIG. 9, a projector 10F in the modification 4 has a spherical external shape. In the projector 10F, the entire surface of an exterior case 11F configures the acoustic diffusion unit 30F and the acoustic diffusion unit 30F is a spherical surface.

By reflecting sound with the spherical surface, the sound can be uniformly diffused. That is, the sound can be uniformly diffused toward the entire periphery. Even when the projector 10F is present at any rotation position, the shape of the acoustic diffusion unit 30F is the same when viewed from the speaker 26 side. Therefore, it is possible to eliminate the influence on a sound effect involved in adjustment in the projection direction.

A configuration in which a plurality of convex sections are arranged side by side on a spherical surface can be adopted by applying the modifications 2 and 3 of the first embodiment to the acoustic diffusion unit 30F.

### Fourth Embodiment

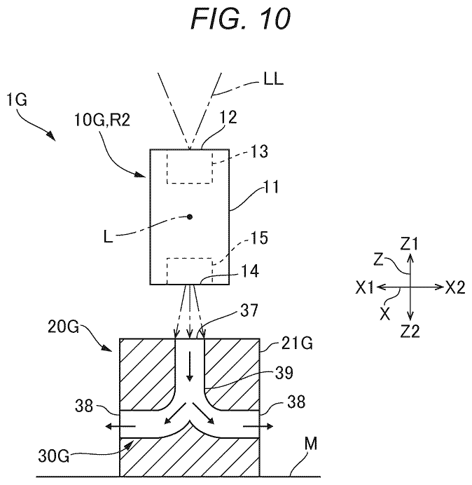

FIG. 10 is a side view of a projector with stand 1G in a fourth embodiment. The projector with stand 1G includes a projector 10G and a stand 20G that supports the projector 10G. The stand 20G includes an acoustic diffusion unit 30G in a part facing the projector 10G. The projector 10G is configured the same as the projector 10 in the first embodiment and includes the sound emitting port 14 and the speaker 15 that face the side opposite to the projection port 12.

The stand 20G includes a base 21G and a pair of support columns extending in the Z1 direction from the base 21G. The projector 10G is coupled to the tips of the pair of support columns and rotatably coupled to a rotation support unit provided at the tips of the support columns. Accordingly, the projector 10G is rotatably supported centering on the rotation axis L extending in the Y direction. In FIG. 10, illustration of the pair of support columns and the rotation support unit is omitted. A rotation range of the projector 10G includes the second rotation position R2 (see FIG. 10) where the speaker 15 faces the stand 20G.

The acoustic diffusion unit 30G diffuses sound through the inside of the stand 20G. The acoustic diffusion unit 30G includes a sound receiving port 37 opened on a surface facing the projector 10G, a sound emitting port 38 opened on a surface different from the surface facing the projector 10G, and an acoustic transmission path 39 for causing the sound receiving port 37 and the sound emitting port 38 to communicate. Sound entering the acoustic transmission path 39 from the sound receiving port 37 is reflected by the inner surface of the acoustic transmission path 39, transmitted to the sound emitting port 38, and emitted from the sound emitting port 38. In an example illustrated in FIG. 10, the sound receiving port 37 is opened on the upper surface of the stand 20G. The sound emitting port 38 is opened on the side surface of the stand 20G. A plurality of sound emitting ports 38 are provided. The number of sound emitting port 38 is not particularly limited and may be one or plural. When the plurality of sound emitting ports 38 are provided, the acoustic transmission path 39 branches halfway and causes the sound emitting ports 38 and the sound receiving port 37 to communicate.

### Action Effects of the Fourth Embodiment

In the projector with stand 1G in the fourth embodiment, even when sound is emitted from the projector 10G toward the stand 20G, the sound is transmitted on the inside of the acoustic diffusion unit 30G and diffused to the outside from the sound emitting port 38. Therefore, it is possible to suppress deterioration in a sound effect due to the sound emitted from the projector 10G being blocked by the stand 20G. In particular, it is possible to suppress deterioration in a sound effect due to sound in a high frequency range being less easily diffused. Therefore, it is possible to suppress deterioration in a sense of presence obtained from a video with sound.

As in the first embodiment, various shapes such as a rectangular parallelepiped shape, a cylindrical shape, and a spherical shape can be adopted as the external shape of the projector 10G. A surface on which the sound emitting port 14 is provided is not limited to the rear surface of the projector 10G. Further, a configuration in which the projector 10 is fixed to the stand 20G in a posture in which the speaker 15 faces the stand 20G side may be adopted.

### Summary of the Present Disclosure

The present disclosure will be summarized below as appendices.

### Appendix 1

A projector with stand including:
a projector including a projection port;
a speaker disposed in the projector; and
a stand configured to support the projector, wherein an acoustic diffusion unit configured to reflect and diffuse sound emitted from the speaker is provided on a surface of the stand facing the projector.

According to the appendix 1, the sound emitted from the speaker toward the stand is reflected and diffused by the acoustic diffusion unit. Therefore, even sound in a high frequency range can be spread.

### Appendix 2

The projector with stand according to the appendix 1, wherein the acoustic diffusion unit has a convex shape protruding to a projector side.

According to the appendix 2, the reflected sound travels toward an outer peripheral side. Therefore, it is possible to spread the sound to the surrounding.

### Appendix 3

The projector with stand according to the appendix 2, wherein a surface of the acoustic diffusion unit is a convex curved surface.

According to the appendix 3, the reflected sound can be spread to a wide range.

### Appendix 4

The projector with stand according to the appendix 1, wherein a plurality of convex sections protruding to the projector side are disposed on a surface of the acoustic diffusion unit.

According to the appendix 4, a sound diffusion effect is improved by the plurality of convex sections.

### Appendix 5

The projector with stand according to any one of the appendices 1 to 4, wherein
the stand rotatably supports the projector, and
a rotation range of the projector includes a rotation position where the speaker and the acoustic diffusion unit face each other.

According to the appendix 5, a projection direction can be adjusted. Even when sound is emitted from the speaker toward the stand according to a change in the projection direction, the sound is reflected and diffused by the acoustic diffusion unit. Therefore, even sound in a high frequency range can be spread to the surrounding by the acoustic diffusion unit.

### Appendix 6

A projector with stand including:
a projector including a projection port;
a stand configured to support the projector; and
a speaker disposed in the stand, wherein
an acoustic diffusion unit configured to reflect and diffuse sound emitted from the speaker is provided on a surface of the projector facing the stand.

According to the appendix 6, the sound emitted from the speaker toward the projector is reflected and diffused by the acoustic diffusion unit. Therefore, even sound in a high frequency range can be spread.

### Appendix 7

The projector with stand according to the appendix 6, wherein
the stand rotatably supports the projector, and
a rotation range of the projector includes a rotation position where the speaker and the acoustic diffusion unit face each other.

According to the appendix 7, a projection direction can be adjusted. The sound emitted from the speaker toward the projector is reflected and diffused by the acoustic diffusion unit. Therefore, even sound in a high frequency range can be spread.

### Appendix 8

The projector with stand according to the appendix 6 or 7, wherein
the projector includes a rear surface facing a side opposite to the projection port and includes a pair of side surfaces intersecting with a front-rear direction from the projection port toward the rear surface and facing both sides in a direction intersecting a rotation axis of the projector,
the acoustic diffusion unit is provided on the rear surface and the pair of side surfaces, and
the stand rotatably supports the projector in a range including a first rotation position where the speaker faces one of the pair of side surfaces, a second rotation position where the speaker faces the rear surface, and a third rotation position where the speaker faces another of the pair of side surfaces.

According to the appendix 8, the projection direction can be adjusted over a wide range of 180° or more. At the first rotation position, the second rotation position, and the third rotation position, the sound emitted from the speaker toward the projector is reflected and diffused by the acoustic diffusion unit. Therefore, even sound in a high frequency range can be spread.

### Appendix 9

The projector with stand according to the appendix 6 or 7, wherein an external shape of the projector is a spherical shape.

According to the appendix 9, the sound can be uniformly diffused. Even if the projection direction is changed, the shape of the acoustic diffusion unit does not change when viewed from the speaker side. Therefore, the change in the projection direction does not affect a sound effect.

### Appendix 10

A projector with stand including:
a projector including a projection port;
a speaker disposed in the projector; and
a stand configured to support the projector, wherein
the stand includes:
a sound receiving port opened on a surface facing the projector;
a sound emitting port opened on a surface different from the surface facing the projector; and
an acoustic transmission path configured to cause the sound receiving port with the sound emitting port to communicate.

According to the appendix 10, sound can be diffused using the acoustic transmission path provided inside the stand.

What is claimed is:

1. A projector with stand including:
a projector including a projection port;
a speaker disposed in the projector; and
a stand configured to support the projector, wherein
an acoustic diffusion unit configured to reflect and diffuse sound emitted from the speaker is provided on a surface of the stand facing the projector.

2. The projector with stand according to claim 1, wherein the acoustic diffusion unit has a convex shape protruding to a projector side.

3. The projector with stand according to claim 2, wherein a surface of the acoustic diffusion unit is a convex curved surface.

4. The projector with stand according to claim 1, wherein a plurality of convex sections protruding to the projector side are disposed on a surface of the acoustic diffusion unit.

5. The projector with stand according to claim 1, wherein
the stand rotatably supports the projector, and
a rotation range of the projector includes a rotation position where the speaker and the acoustic diffusion unit face each other.

6. A projector with stand including:
a projector including a projection port;
a stand configured to support the projector; and
a speaker disposed in the stand, wherein
an acoustic diffusion unit configured to reflect and diffuse sound emitted from the speaker is provided on a surface of the projector facing the stand.

7. The projector with stand according to claim 6, wherein
the stand rotatably supports the projector, and
a rotation range of the projector includes a rotation position where the speaker and the acoustic diffusion unit face each other.

8. The projector with stand according to claim 6, wherein
the projector includes a rear surface facing a side opposite to the projection port and includes a pair of side surfaces intersecting with a front-rear direction from the projection port toward the rear surface and facing both sides in a direction intersecting a rotation axis of the projector,
the acoustic diffusion unit is provided on the rear surface and the pair of side surfaces, and
the stand rotatably supports the projector in a range including a first rotation position where the speaker faces one of the pair of side surfaces, a second rotation position where the speaker faces the rear surface, and a third rotation position where the speaker faces another of the pair of side surfaces.

9. The projector with stand according to claim 6, wherein an external shape of the projector is a spherical shape.

10. A projector with stand including:
a projector including a projection port;
a speaker disposed in the projector; and
a stand configured to support the projector, wherein
the stand includes:
a sound receiving port opened on a surface facing the projector;
a sound emitting port opened on a surface different from the surface facing the projector; and
an acoustic transmission path configured to cause the sound receiving port with the sound emitting port to communicate.
